(19) United States
(12) Patent Application Publication
(10) Pub. No.: US 2021/0140464 A1
(43) Pub. Date: May 13, 2021

(54) A SUPPORT FOR A GUDGEON

(71) Applicant: Robert Law, Taihape (NZ)

(72) Inventor: Robert Law, Taihape (NZ)

(21) Appl. No.: 16/972,142

(22) PCT Filed: May 29, 2019
(86) PCT No.: PCT/NZ2019/050057

§ 371 Date: Dec. 4, 2020

(30) Foreign Application Priority Data
Jun. 7, 2018 (NZ) 743285

(51) Int. Cl. F16B 37/04; E05D 5/02; E06B 11/04; E05D 3/02; E05D 5/10; F16M 13/02

(52) U.S. Cl. CPC F16B 37/048; E05D 5/02; E06B 11/04; E05D 3/02; E05Y 2900/40; F16M 13/02; E05Y 2600/51; E05Y 2600/62; E05D 5/10

(57) ABSTRACT

This invention relates to a support for a gudgeon. It is known to hang gates on posts by way of gudgeons. Over time the load and movement of the gate may cause the gudgeon to loosen. In this regard the hole that the gudgeon is screwed into becomes ‘over-sized’ due to wear and tear. This may necessitate replacing the gudgeon, or screwing it into another part of the post. It is an object of a preferred embodiment of the invention to address this problem. In this regard there is a support having a hub and a series of spikes. The gudgeon passes through the hub and the spikes are imbedded in a post. The arrangement is such that the support 1 takes up at least some tipping force on the gudgeon.

### FIELD OF INVENTION

The invention relates to a support for a gudgeon. A preferred form of the invention relates to a support for use in securing a gudgeon to a fencepost.

### BACKGROUND

It is known to hang gates on posts by way of gudgeon connections. The gudgeon may be in the form of an “L” shaped bolt screwed into the post so that one of its arms extends vertically. A complimentary loop secured to a gate is fitted around the vertical arm of the gudgeon. The arrangement is such that the gate can swing open and shut on the ‘gudgeon-loop’ combination. Preferably there are at least two ‘gudgeon-loop’ combinations per post and per gate, one above the other.

Over time the load and movement of the gate on the gudgeon may cause the gudgeon to become loose. In this regard the post hole that the gudgeon is screwed into becomes ‘over-sized’ due to wear and tear. This can necessitate replacing the gudgeon, or screwing the gudgeon into another part of the post and adjusting the position of the associated gate loop.

### OBJECT OF THE INVENTION

It is an object of preferred embodiments of the invention to go at least some way towards addressing the above problem. While this applies to preferred embodiments, it should be understood that the object of the invention per se is simply to provide a useful choice. Accordingly, any objects applicable to preferred embodiments should not be taken as a limitation on the scope of any claims expressed more broadly.

### INTERPRETATION

The term “comprises”, or derivatives thereof, should not be interpreted as excluding other features. For example, if used in relation to a combination of features it indicates that optionally, but not necessarily, there may be additional features that have not been mentioned.

Terms such as ‘upper’ or ‘lower’ when used in relation to certain items in the drawings refer to the orientation those items have in the drawings. Such terms are used for ease of explanation. However, it should be understood that when in storage or use those items may have a different orientation.

### SUMMARY OF THE INVENTION

According to one aspect of the invention there is provided a support for a gudgeon comprising:
a hub; and
at least one spike integral with and extending from the hub;
   the support being arranged such that:
the gudgeon passes through the hub;
the gudgeon and spike are tightly imbedded in a post; and
the support takes up at least some tipping force on the gudgeon to protect the gudgeon against becoming loose in the post.

Optionally the support has more than one spike, each of which is tightly imbedded in the post.

Optionally there is nut located in an opening of the hub and held against rotation, the arrangement being such that the gudgeon passes through the nut.

Optionally the gudgeon is in threaded connection with the nut.

Optionally the hub is generally triangular is transverse cross-section.

Optionally support has a series of inner spikes, each extending from a respective corner of the hub.

Optionally support has a series of outer spikes, each dog-legged with respect to the hub.

Optionally at least some of the outer spikes have a hole that receives a fixing member (eg a nail or screw) imbedded in the post.

Optionally the nut has a triangular transverse cross section at one end that is complimentary to and in contact with the hub.

Optionally the nut has a hexagonal transverse cross section at one end that is at least mainly outside the hub.

### IMAGES

Some preferred embodiments of the invention will now be described by way of example and with reference to the accompanying images, of which:

FIG. 1 is an isometric exploded view of a support for a fencepost gudgeon;

FIG. 2 is an overhead view of the support when assembled;

FIG. 3 is an isometric view of the assembled support from below;

FIG. 4 is an isometric overhead view of a nut forming part of the support;

FIG. 5 is an isometric view of the nut from below;

FIG. 6 is an isometric view of the support when installed in a fencepost with a gudgeon;

FIG. 7 is an isometric view of a wedge for use with the support; and

FIG. 8 is an isometric view of a tool for use in installing the support.

FIG. 9 is a side view of the support when used with a stay post.

### DETAILED DESCRIPTION

Referring to FIGS. 1, 2 and 3, the gudgeon support 1 comprises a triangular hub 2 that has a channel-like central opening 3 passing all the way through. The hub is therefore sleeve-like. The hub's inner side walls are shaped to receive a nut 4 in a snug fit. The arrangement is such that when the nut 4 is in the opening 3 it cannot turn. Alternatively, the nut 4 may be welded to the hub 3 and in some embodiments the nut 4 may be absent.

As shown, each lower corner of the hub 2 is secured to, or integral with, an ‘inner’ spike 5 (there are three of these). As also shown, each outside wall of the hub 2 is secured to, or integral with, an outer spike 6 (there are also three of these).

Each outer spike 6 is generally dog-legged and engages the hub at an angle of about 30° to the horizontal. The sharp ends of the inner and outer spikes 5, 6 are co-planar. In other words, none extends to a point lower than the others. The upper surface of each outer spike 6 has a hole 7 for receiving a nail or screw or the like.

Referring to FIGS. 4 and 5, the upper end of the nut 4 is hexagonal, and the lower end is triangular so as to compliment the shape of the hub's opening 3.

Preferably all the parts of the support 1 are made from a robust metallic material, for example steel. The outer spikes 6 may be secured to the hub 2 by welding. The inner spikes 5 are integral with the hub 2.

Referring to FIG. 6, when the support is in use the spikes 5, 6 are driven into the side of a fence post 8 so that the hub 2 is secured there. The hub's opening 3 therefore extends horizontally. A drill bit, for example 20 mm, is used to create a hole in the post, aligned with the longitudinal axis of the hub's opening 3. Alternatively, the hole may have been pre-drilled, and the hub's opening 3 subsequently aligned with it. In either case the triangular end of the nut 4 is placed in the opening 3 so that the nut cannot turn. The nut's hexagonal end extends outside the hub's opening 3.

A gudgeon 9 is screwed through the nut 4 and into the hole in a tight fit with the post. To facilitate this the nut 4 and gudgeon 9 have complimentary threaded sides. In this regard the inner bore of the nut 4 is threaded to enable it to engage a threaded portion on the outside of the gudgeon 9. The arrangement is such that when imbedded in the post the outer arm 10 of the gudgeon extends vertically, upwards. Nails or screws are driven into the post through the holes 7. These, together with the spikes 5, 6, provide a secure fit between the support 1 and the post 8. Another support 1 is fitted to the post, above or below the other, by the same process. The support 1 may be secured to the post in any rotational orientation with respect to the axis of the hub's opening 3, and left there permanently.

A gate is then hung on the gudgeons 9 so that it can swing open and shut. More particularly, looped steel fittings 11 secured to the gate are fitted around the gudgeons. The weight of the gate keeps it from falling off, although it can be lifted up and off with deliberate movements, if desired.

The support 1 protects against the gudgeon becoming lose in its post hole due to the weight and movement of the gate. This is because tipping force on the gudgeon is to at least a large degree taken up by the support 1 and through the nut 4 if present.

Referring to FIG. 7, a generally TT-shaped spacer 12 may be used to reduce the effective size of the hub's opening 3 for use with narrower gudgeons and a support 1 when no nut 4 is used. In such instances, when a gudgeon is positioned in the hub 2, the spacer 12 is hammered in so that its sharp ends 13 are positioned in two of the hub's 2 corners. The effect of this is to tighten the gudgeon against inside walls of the hub 2.

In some embodiments of the invention the gudgeon may be fitted into the opening 3 of the hub without the use of a nut 4. In that case the inside walls of the hub 2 may have narrow and shallow grooves for engaging complimentary protruding parts in the side of the gudgeon i.e. the thread. The spacer 12 may also be used to provide further support.

Referring to FIG. 8, a gauge stand 14 may be used for installing the support 1 to a post. The stand 14 has an upright rail 15, a sliding sleeve 16, a handle 17, a threaded punch 18, a punch nut 19 and a support sleeve 20.

The gauge stand 14 provides a convenient way to get the support 1 into the post at the right height. In this regard the elevation of the support sleeve 20, and therefore of the punch 18, can be changed by turning the handle 17 to loosen the sliding sleeve 16. This enables that sleeve 16 to move up and down the rail 15. When the sleeve 16 is at the desired height it is locked there by turning the handle 17 back to a locking position.

The support 1 with its nut 4 already installed is screw fitted to the forward (right hand) end of the punch 18. More specifically, the thread of the punch 18 engages the internal thread of the nut 4. The arrangement is such that the punch nut 19 is butted up against and behind the nut 4.

The opposite (left hand) end of the punch 18 is then hit with a hammer to drive the spikes 5, 6, and therefore the support 1, partially into the post. This is possible as the punch 18 sits loosely in the support sleeve 20. The gauge stand 14 is then removed and the spikes are driven all the way into the post by way of the hammer.

If desired, the gauge stand 14 can be used without the punch 18 and punch nut 19 to help drill a gudgeon hole in the post at the right height. In this regard the support sleeve 20 can be used to line up a drill with the post; the bit of the drill being inserted into the sleeve 20 and centred by eye before drilling.

Referring to FIG. 9, the support 1 can be used to connect a ‘post’ in the form of a diagonal stay 21 to a vertical post 22. In this case the gudgeon 23 is straight rather than L-shaped. The spikes 5, 6 and one end of the gudgeon are embedded in the stay, and the opposite end of the gudgeon is drilled and screwed into the vertical post 22.

While some preferred embodiments of the invention have been described by way of example, it should be appreciated that modifications and improvements can occur without departing from the scope of the following claims.

1. A support for a gudgeon comprising:
a hub,
an inner spike integral with and extending from the hub; and
a series of dog-legged spikes extending either side of the inner spike;
the support being arranged such that:
the gudgeon passes through ale hub;
the gudgeon and spikes are tightly imbedded in a post; and
the support takes up at least some tipping force on the gudgeon to protect the gudgeon against becoming loose in the post.

2. A support according to claim 1, comprising more than one inner spike, each being between a respective pair of the dog-legged spikes, each of the inner and dog-legged spikes being tightly imbedded in the post.

3. A support according to claim 1, wherein there are three of the dog-legged spikes.

4. A support according to claim 1, wherein there is a nut located in an opening of the hub and is held against rotation, the arrangement being such that the gudgeon passes through the nut.

5. A support according to claim 4, wherein the gudgeon is in threaded connection with the nut.

6. A support according to claim 1, wherein the hub is generally triangular is transverse cross-section.

7. A support according to claim 2, wherein the inner spikes are in a substantially triangular configuration, each inner spike extending from a respective corner of the hub.

8. A support according to claim 1, wherein the dog-legged spikes are tilted with respect to the hub.

9. A support according to claim 1, wherein at least some of the dog-legged spikes each have a hole that receives a fixing member imbedded in the post.

10. A support according to claim 4, wherein the nut has a triangular transverse cross section at one end that is complimentary to and in contact with the hub.

11. A support according to claim 4, wherein the nut has a hexagonal transverse cross section at one end that is at least mainly outside the hub.

12. A support according to claim 1, wherein the spiked end of each dog-legged spike is spaced from the spiked end of the inner spike.

13. A support according to claim 1 comprising:
the inner spike extending from the hub and imbedded in the post;
the series of dog-legged spikes imbedded in the post, each extending from the hub;
a nut in threaded connection with the outside of the gudgeon and fitted snugly in a channel that passes through the hub;
the support being such that:
each spike in the series of dog-legged spikes is titled with respect to the hub; and
the hub is generally triangular in transverse cross section.

14. A support according to claim 13, wherein:
there are three of the inner spikes, each extending from a respective corner of the hub; and
there are three of the dog-legged spikes, each extending from a respective outer side of the hub.

15. (canceled)

16. A support according to claim 1, wherein the post comprises a diagonal stay.
